(19) United States
(12) Patent Application Publication
(10) Pub. No.: US 2026/0024936 A1
(43) Pub. Date: Jan. 22, 2026

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yasunori ASANO, Mie (JP); Shinji TANAKA, Mie (JP); Yutaka KOBAYASHI, Mie (JP)

(21) Appl. No.: 18/869,285

(22) PCT Filed: May 8, 2023
(86) PCT No.: PCT/JP2023/017248

§ 371 Date: Nov. 26, 2024

(30) Foreign Application Priority Data
May 27, 2022 (JP) 2022-086609

(51) Int. Cl. H01R 13/24; H01R 13/658; H01R 24/50

(52) U.S. Cl. CPC H01R 13/2407; H01R 24/50; H01R 13/658

(57) ABSTRACT

A connector includes a terminal module including an inner conductor, an insulator surrounding the inner conductor and a tubular outer conductor surrounding the insulator, a mating connection conductor including an opening extending around a center axis of the outer conductor, and a plurality of spring connecting portions arranged side by side along a circumferential direction of the outer conductor on an outer peripheral side of the outer conductor. The plurality of spring connecting portions are arranged side by side along the circumferential direction of the outer conductor. Each of the plurality of spring connecting portions extends from an edge of the opening toward the outer conductor and is resiliently pressed against an outer peripheral part of the outer conductor when viewed along the center axis of the outer conductor.

### TECHNICAL FIELD

The present disclosure relates to a connector.

### BACKGROUND

Patent Document 1 discloses GND connection achieved by bringing a shim provided in a coaxial connector and a shield case into contact. Further, the shim is disclosed to be electrically conductive and resilient.

### PRIOR ART DOCUMENT

### Patent Document

Patent Document 1: JP 2005-026021 A

### SUMMARY OF THE INVENTION

### Problems to be Solved

The electrical conductivity and resilience of shim are possibly realized by working a part of a metal plate into a spring shape. In this case, a gap is possibly formed around a spring. It is desired to improve an electromagnetic shielding property by making the gap around the spring as small as possible.

Accordingly, the present disclosure aims to improve an electromagnetic shielding property by making a gap between an outer conductor and a mating connection conductor as small as possible when the outer conductor of a connector and the mating connection conductor are connected by spring connecting portions.

### Means to Solve the Problem

The present disclosure is directed to a connector with a terminal module including an inner conductor, an insulator surrounding the inner conductor and a tubular outer conductor surrounding the insulator, a mating connection conductor including an opening extending around a center axis of the outer conductor, and a plurality of spring connecting portions arranged side by side along a circumferential direction of the outer conductor on an outer peripheral side of the outer conductor, the plurality of spring connecting portions being arranged side by side along the circumferential direction of the outer conductor, and each of the plurality of spring connecting portions extending from an edge of the opening toward the outer conductor and being resiliently pressed against an outer peripheral part of the outer conductor when viewed along the center axis of the outer conductor.

### Effect of the Invention

According to the present disclosure, an electromagnetic shielding property can be improved by making a gap between an outer conductor and a mating connection conductor as small as possible when the outer conductor of a connector and the mating connection conductor are connected by spring connecting portions.

### BRIEF DESCRIPTION OF THE DRAWINGS

FIG. 1 is a perspective view showing a device provided with a connector according to one embodiment.

FIG. 2 is a section along II-II of FIG. 1.

FIG. 3 is a perspective view showing a second case and the connector from inside.

FIG. 4 is a perspective view showing the connector from outside.

FIG. 5 is an exploded perspective view of the connector.

FIG. 6 is a back view of the connector.

### DETAILED DESCRIPTION TO EXECUTE THE INVENTION

### Description of Embodiments of Present Disclosure

First, embodiments of the present disclosure are listed and described.

The connector of the present disclosure is as follows.
(1) The connector of the present disclosure is provided with a terminal module including an inner conductor, an insulator surrounding the inner conductor and a tubular outer conductor surrounding the insulator, a mating connection conductor including an opening extending around a center axis of the outer conductor, and a plurality of spring connecting portions arranged side by side along a circumferential direction of the outer conductor on an outer peripheral side of the outer conductor, the plurality of spring connecting portions being arranged side by side along the circumferential direction of the outer conductor, and each of the plurality of spring connecting portions extending from an edge of the opening toward the outer conductor and being resiliently pressed against an outer peripheral part of the outer conductor when viewed along the center axis of the outer conductor.

According to the present disclosure, the outer conductor and the mating connection conductor can be more reliably connected by the spring connecting portions. Further, since each of the plurality of spring connecting portions extends from the edge of the opening toward the outer conductor and is resiliently pressed against the outer peripheral part of the outer conductor when viewed along the center axis of the outer conductor, gaps between the spring connecting portions are easily made smaller. In this way, an electromagnetic shielding property can be improved by reducing a gap between the outer conductor and the mating connection conductor as much as possible.
(2) In the connector of (1), an intervening member may be provided which includes an annular portion along the opening and the plurality of spring connecting portions, the intervening member being separate from the outer conductor and the mating connection conductor, the annular portion may be electrically connected to the mating connection conductor on an outer periphery of the opening, and the plurality of spring connecting portions may be so supported on the annular portion that parts connected to the annular portion serve as spring fulcrums.

In this case, since the spring connecting portions are formed in the intervening member separate from the outer conductor and the mating connection conductor, the spring connecting portions can be easily formed.
(3) In the connector of (2), the annular portion may include an intervening tube portion having a first opening and a second opening, and a protruding portion extending outward from an edge of the first opening, the protruding portion may be in contact with any one of principal surfaces of the mating connection conductor on the outer periphery of the opening, and the plurality of spring connecting portions may be supported on an edge of the second opening and extend inwardly of the edge of the second opening.

In this case, the plurality of spring connecting portions can be brought into contact with the outer conductor at positions different along an axial direction of the outer conductor with respect to the opening of the mating connection conductor. In this way, a degree of freedom in arranging the outer conductor with respect to the opening can be enhanced.
(4) In the connector of (3), the protruding portion may be fixed to one principal surface of the mating connection conductor on the outer periphery of the opening, and the intervening tube portion may project toward the other principal surface of the mating connection conductor through the opening. In this way, the intervening member can be firmly fixed to the mating connection conductor.
(5) In the connector of any one of (1) to (4), each of the plurality of spring connecting portions may be shaped to be narrower on a tip than on a base end. In this way, the mutual interference of the tips of the plurality of spring connecting portions can be suppressed.
(6) In the connector of any one of (1) to (5), each of the plurality of spring connecting portions may include a gradually narrowed part gradually narrowed toward a tip side. In this way, the tips of the plurality of spring connecting portions can be made less likely to interfere with each other while gaps between the plurality of spring connecting portions are made as small as possible at the gradually narrowed parts.
(7) In the connector of any one of (1) to (6), the plurality of spring connecting portions may extend in a radial direction of a circle centered on the center axis of the outer conductor when viewed along the center axis of the outer conductor. In this way, a force for pressing the spring connecting portions against the outer peripheral part of the outer conductor toward the center axis of the outer conductor is easily applied.
(8) In the connector of (7), the plurality of spring connecting portions may be uniformly scattered along the edge of the opening when viewed along the center axis of the outer conductor. In this way, the respective spring connecting portions are pressed against the outer conductor in a well-balanced manner.
(9) In the connector of any one of (1) to (8), the plurality of spring connecting portions may be pressed against the outer peripheral part of the outer conductor at the same position in a direction along the center axis of the outer conductor. In this way, the gaps between the spring connecting portions can be made as small as possible.
(10) In the connector of any one of (1) to (9), each of the plurality of spring connecting portions may include a spring body extending in an oblique direction with respect to the center axis of the outer conductor and a contacting tip portion connected to a tip of the spring body, and the contacting tip portion may extend from the tip of the spring body in a direction oblique to the center axis of the outer conductor and away from the center axis. In this way, the outer conductor is easily inserted into a part surrounded by the plurality of spring connecting portions.

### Details of Embodiment of Present Disclosure

A specific example of a connector of the present disclosure is described with reference to the drawings. Note that the present disclosure is not limited to these illustrations, but is represented by claims and intended to include all changes in the scope of claims and in the meaning and scope of equivalents.

### EMBODIMENT

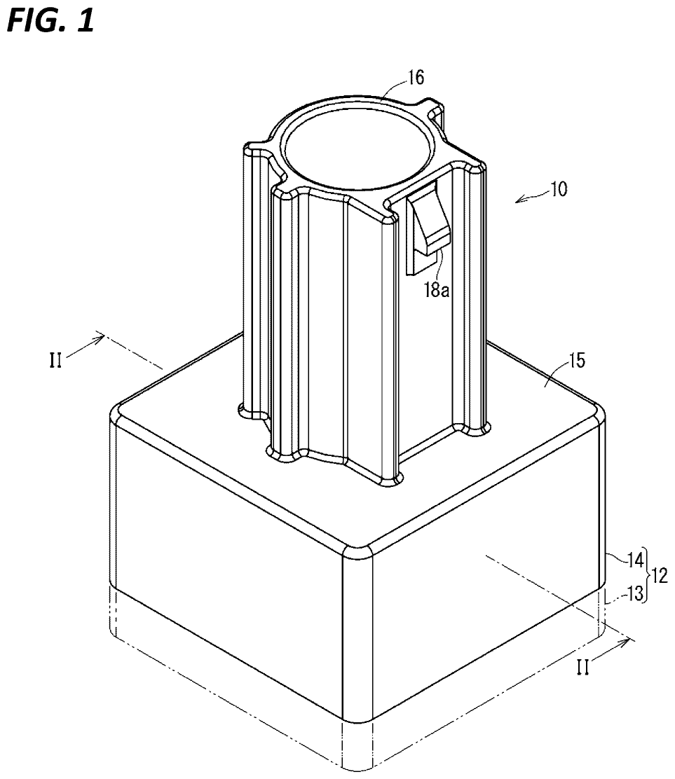

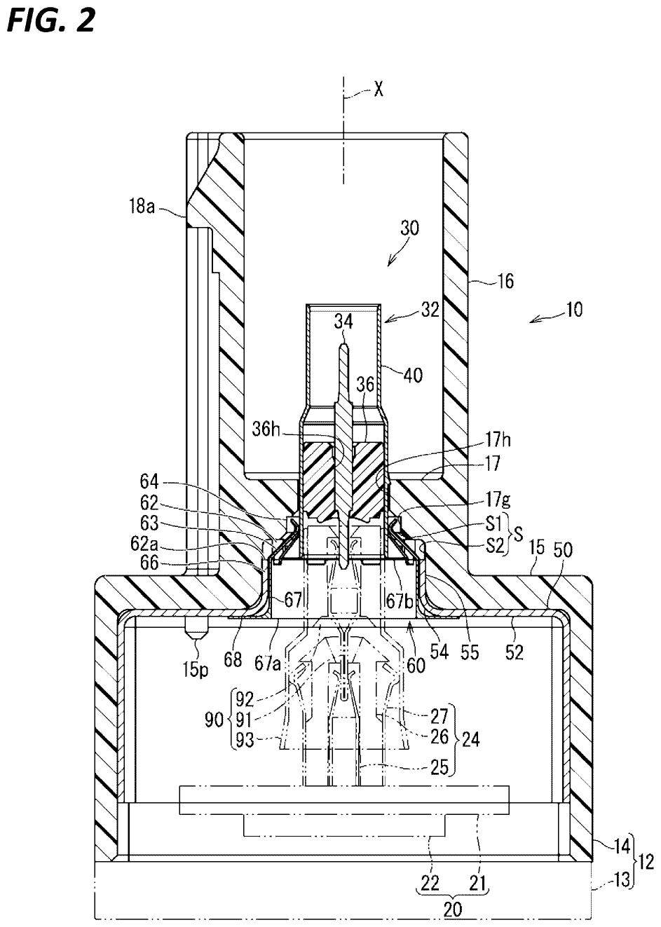

Hereinafter, a connector according to an embodiment is described. FIG. 1 is a perspective view showing a device 10 provided with a connector 30. FIG. 2 is a section along II-II of FIG. 1.

### Concerning Overall Configuration of Device The device 10 is, for example, a camera device. The camera device is, for example, an in-vehicle device. The device 10 may not be a camera device.

The device 10 is provided with a case 12, an electrical component 20 and the connector 30. The electrical component 20 is accommodated in the case 12. The connector 30 is a connector for connecting the electrical component 20 and an external electrical component. For example, the connector 30 is a connector, to which a cable connected to the external electrical component is connected. The cable connected to the connector 30 is, for example, a coaxial cable.

The case 12 is provided with a first case 13 and a second case 14. The first and second cases 13, 14 are, for example, made of resin. By uniting the first and second cases 13, 14, the case 12 in the form of a rectangular parallelepiped box for accommodating the electrical component 20 is configured. If the device 10 is a camera device, it is assumed that the first case 13 includes a lens or window for imaging and the second case 14 includes the connector 30.

The electrical component 20 is, for example, a mounting board, in which electronic components are mounted on a board. If the device 10 is a camera device, the electrical component 20 is assumed to include a circuit board 21 and an imaging element 22 mounted on the circuit board 21. The imaging element 22 faces the lens or window for imaging of the first case 13 and images an outside view by turning the lens or window. The side of the first case 13, toward which the imaging element 22 is facing, may be referred to as a front side, and the side of the second case 14 opposite to the front side may be referred to as a rear side.

In this embodiment, the electrical component 20 is provided with a board-side connector 24 located on a surface of the circuit board 21 opposite to the imaging element 22. The board-side connector 24 is, for example, provided with a board-side inner conductor 25, a board-side insulator 26 and a board-side outer conductor 27. The board-side inner conductor 25 is surrounded by the board-side insulator 26. A dielectric can be grasped as one type of insulator, and the board-side insulator 26 may be a dielectric. The board-side insulator 26 is surrounded by the board-side outer conductor 27. The board-side connector 24 projects from the circuit board 21 toward the connector 30.

A relay connector 90 is connected to the board-side connector 24. The relay connector 90 is, for example, provided with a movable-side inner conductor 91, a movable-side insulator 92 and a movable-side outer conductor 93. The movable-side inner conductor 91 is surrounded by the movable-side insulator 92. A dielectric can be grasped as one type of insulator, and the movable-side insulator 92 may be a dielectric. The movable-side insulator 92 is surrounded by the movable-side outer conductor 93. With the movable-side inner conductor 91 inserted and connected to the board-side inner conductor 25 and the board-side outer conductor 27 inserted and connected to the movable-side outer conductor 93, the relay connector 90 is connected to the board-side connector 24. The relay connector 90 projects further toward the connector 30 from the board-side connector 24. The relay connector 90 relays and connects the board-side connector 24 and the connector 30. The relay connector 90 is posture-changeably connected to the board-side connector 24 and the connector 30.

The connector 30 is provided on the side of the second case 14, i.e. on a rear side of the case 12. The relay connector 90 is connected to the connector 30 in the case 12. By connecting a cable from outside to the connector 30, an external electrical component as a connection destination of this cable and the electrical component 20 in the case 12 are electrically connected.

### Connector

The connector 30 is more specifically described.

### Overall Configuration of Connector

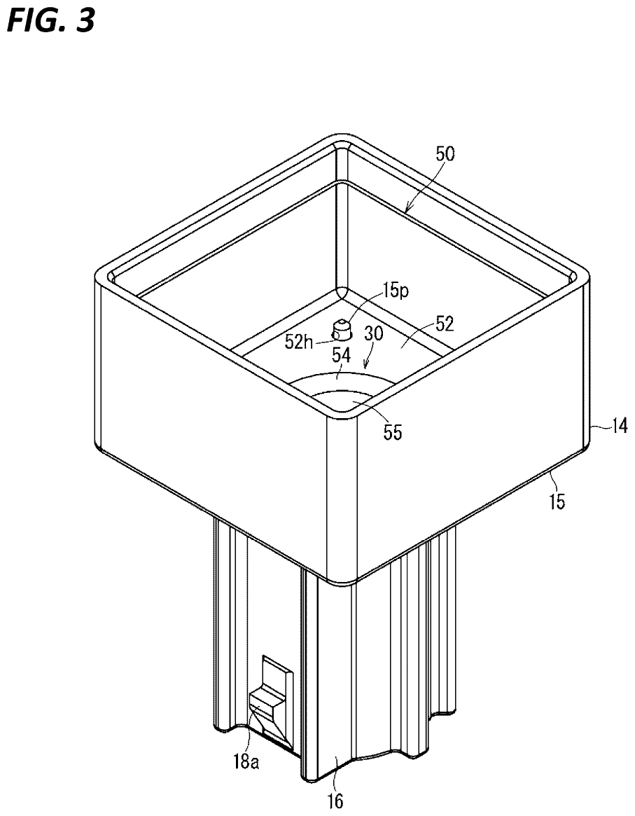

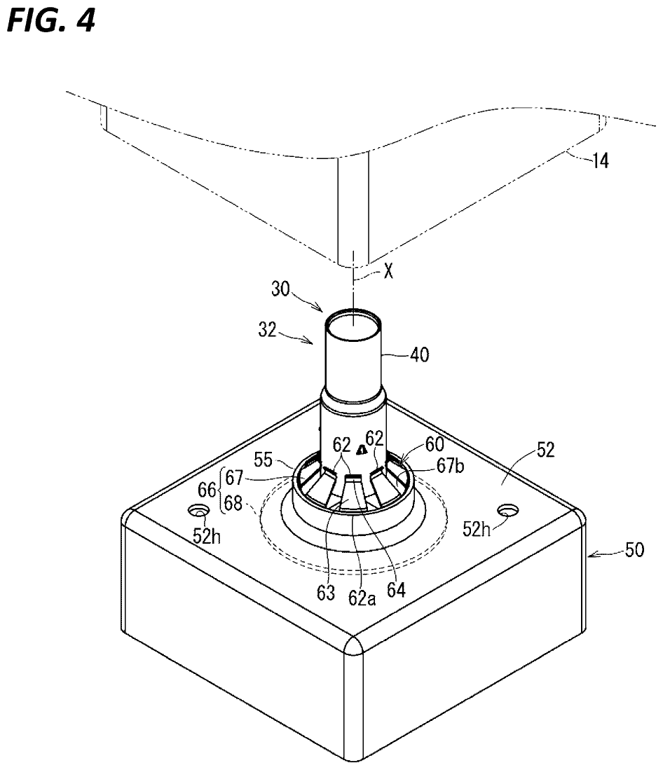

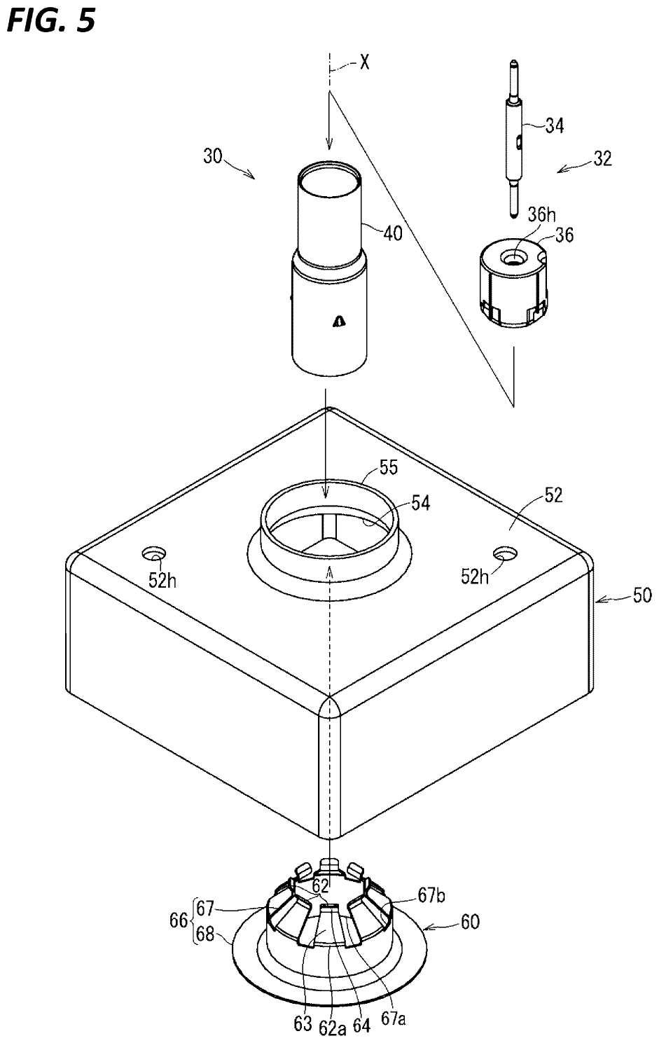

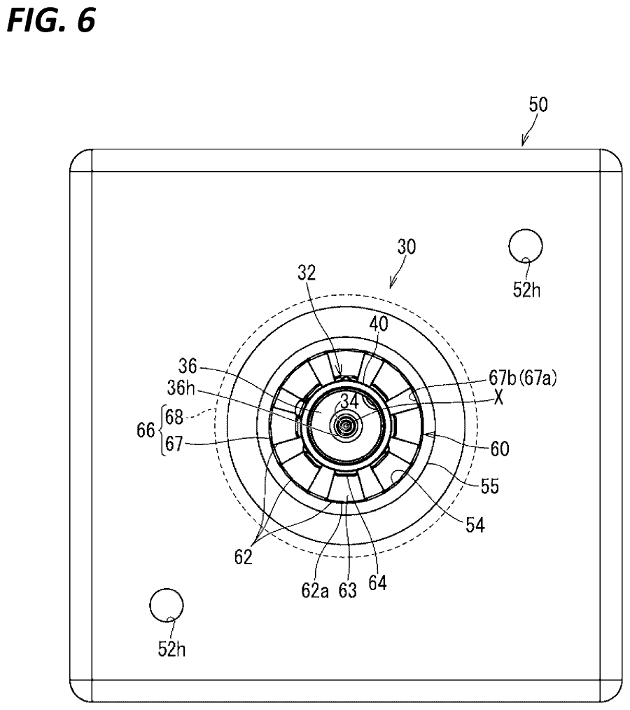

FIG. 3 is a perspective view showing the second case 14 and the connector 30 from inside. FIG. 4 is a perspective view showing the connector 30 from outside. FIG. 5 is an exploded perspective view of the connector 30. FIG. 6 is a back view of the connector 30.

As shown in FIGS. 2 to 6, the connector 30 is provided with a terminal module 32, a mating connection conductor 50 and a plurality of spring connecting portions 62.

The terminal module 32 is provided with an inner conductor 34, an insulator 36 and an outer conductor 40. The insulator 36 surrounds the inner conductor 34. A dielectric can be grasped as one type of insulator, and the insulator 36 may be a dielectric. The outer conductor 40 is formed into a tubular shape and surrounds the insulator 36.

The mating connection conductor 50 is a conductor as an electrical connection destination of the outer conductor 40 and made of metal or the like. In this embodiment, the mating connection conductor 50 is a shield conductor for electromagnetically shielding between the electrical component 20 and outside. More specifically, the mating connection conductor 50 is in the form of a rectangular parallelepiped box open on one side, and arranged along the inner side surface of the second case 14. The mating connection conductor 50 can electromagnetically shield between the electrical component 20 and outside behind the electrical component 20 by being located behind the electrical component 20. The mating connection conductor 50 can electromagnetically shield the board-side connector 24 and the relay connector 90 from outside around and behind these by being located behind the board-side connector 24 and the relay connector 90 while surrounding the board-side connector 24 and the relay connector 90. The mating connection conductor 50 may be formed by deep drawing a metal material, may be formed by press-working a metal plate, may be formed by die molding or may be formed by cutting.

It is not essential that the mating connection conductor 50 has the above shape and, the mating connection conductor may be, for example, in the form of a plate extending along the inner surface of a bottom part of the second case 14. The mating connection conductor may extend toward the first case 13. The mating connection conductor may be electrically connected to a shield conductor on the side of the first case 13.

The terminal module 32 is supported on a bottom portion 15 of the second case 14. The mating connection conductor 50 is also supported in the second case 14. A configuration for supporting the terminal module 32 and the mating connection conductor 50 by the second case 14 is described.

The bottom portion 52 of the mating connection conductor 50 is formed into a shape extending over the entire inner surface of the bottom portion 15 of the second case 14, here a rectangular shape. The bottom portion 52 is formed with holes 52h. Fixing protrusions 15p fittable into the holes 52h are provided to project on the inner surface of the bottom portion 15 of the second case 14. By fitting the fixing protrusions 15p into the holes 52h, the mating connection conductor 50 is supported in the second case 14. For example, the fixing protrusions 15p may be press-fit into the holes 52h. For example, with the fixing protrusions 15p inserted in the holes 52h, tip parts of the fixing protrusions 15p may be melted by heat or the like and the melted and solidified parts may be hooked in a retained state to the peripheral edges of the holes 52h. For example, retaining protrusions may be formed on the tip parts of the fixing protrusions 15p, and the retaining protrusions may come out from the holes 52h and the fixing protrusions 15p may be inserted into the holes 52h, utilizing the resilient deformation of the fixing protrusions 15p or peripheral edge parts of the holes 52h. In this case, after the fixing protrusions 15p are inserted into the holes 52h, the fixing protrusions 15p or the peripheral edge parts of the holes 52h return to an original shape and the retaining protrusions are hooked to the peripheral edge parts of the holes 52h.

A configuration for fixing the mating connection conductor to the second case 14 is not limited to the above example. For example, the mating connection conductor may be fixed to the second case 14 by screwing, an adhesive or the like.

A holding tube portion 16 projects on the bottom portion 15. The holding tube portion 16 is a hollow cylinder and projects outward from a central part of the bottom portion 15. An inner opening of the holding tube portion 16 is open to the inside of the second case 14, and an outer opening of the holding tube portion 16 is open to the outside of the second case 14. A holding/partitioning portion 17 is formed in an axially intermediate part of the holding tube portion 16. In this embodiment, the holding/partitioning portion 17 is formed at a position near the inner opening in the axially intermediate part of the holding tube portion 16. The holding/partitioning portion 17 partitions between a space on the side of the inner opening and a space on the side of the outer opening in the holding tube portion 16. The holding/partitioning portion 17 is formed with a holding hole 17h, and the terminal module 32 is inserted and held in the holding hole 17h.

In this embodiment, a locking protrusion 18a for holding a cable connector mounted on an end part of a cable is formed on an outer peripheral part of the holding tube portion 16. It is not essential that the locking protrusion 18a is formed.

### Terminal Module

The terminal module 32 is more specifically described. As described above, the terminal module 32 is provided with the inner conductor 34, the insulator 36 and the outer conductor 40.

The inner conductor 34 is in the form of an elongated bar and made of an electrically conductive material such as metal. In this embodiment, a longitudinally intermediate part of the inner conductor 34 is thicker than both end parts of the inner conductor 34. The inner conductor 34 may be in the form of a bar having a uniform thickness.

The insulator 36 is made of an insulating material such as resin and surrounds the inner conductor 34. In this embodiment, the insulator 36 is a dielectric. The insulator 36 is formed into a cylindrical shape. A length of the insulator 36 is shorter than that of the inner conductor 34. A through hole 36h is formed along an extension direction of the insulator 36 in a center of the insulator 36. The inner conductor 34 is inserted into the through hole 36h, and the longitudinally intermediate part of the inner conductor 34 is held in the through hole 36h. With the inner conductor 34 held in the insulator 36, the both end parts of the inner conductor 34 project outward from both end surfaces of the insulator 36. The inner conductor 34 may be formed with locking projections to be hooked to the inner peripheral surface of the through hole 36h.

The outer conductor 40 is made of an electrically conductive material such as metal. The outer conductor 40 is formed into a tubular shape surrounding the insulator 36. More specifically, the outer conductor 40 is formed into a hollow cylindrical shape. A length of the outer conductor 40 is larger than that of the insulator 36. In this embodiment, a diameter of an outer part of the outer conductor 40 is smaller than an outer diameter of an inner part in accordance with a thickness of the relay connector 90 or the connector on the cable end part as a connection destination. The outer conductor 40 may have a tubular shape having a uniform diameter or the thickness relationship may be reversed from that in the above case in accordance with the thickness of the connector as the connection destination. The insulator 36 is held in a longitudinally intermediate part of the outer conductor 40, and both ends of the outer conductor 40 project outward from both ends of the insulator 36. The outer conductor 40 may be formed with locking projections to be hooked to any one of the outer peripheral surface and the respective end surfaces of the insulator 36.

The outer conductor 40 may be formed by deep drawing a metal material, may be formed by press-working a metal plate, may be formed by die molding or may be formed by cutting.

The outer conductor 40 is inserted into the holding hole 17h of the holding/partitioning portion 17 and the longitudinally intermediate part of the outer conductor 40 is held by the holding hole 17h. The outer conductor 40 may be held by a frictional holding force between the outer peripheral surface of the outer conductor 40 and the inner peripheral surface of the holding hole 17h. The outer conductor 40 may be formed with projections to be hooked to an inner peripheral part of the holding hole 17h. The outer conductor 40 may be fixed to the holding hole 17h by an adhesive, screwing or the like.

With the outer conductor 17 held by the holding/partitioning portion 17, one end of the outer conductor 40 projects inward from the holding/partitioning portion 17. In this embodiment, an annular recess 17g is formed in a part of the holding/partitioning portion 17 around the holding hole 17h on the side of the mating connection conductor 50. Thus, a space S closer to the mating connection conductor 50 than the holding/partitioning portion 17, out of the holding tube portion 16, includes a cylindrical space S1 in the annular recess 17g and a cylindrical space S2 extending larger than the cylindrical space S1 on a side closer to the mating connection conductor 50 than the cylindrical space S1.

The movable-side outer conductor 93 of the relay connector 90 is inserted and connected to the inner opening of the outer conductor 40 and an inner end part of the inner conductor 34 is inserted and connected to the movable-side inner conductor 91, whereby the relay connector 90 and the connector 30 are connected in the case 12.

In this embodiment, the inner opening of the outer conductor 40 is located outside the bottom portion 15 of the mating connection conductor 50. Thus, an outer end part of the relay connector 90 is inserted into the space S, and the relay connector 90 and the connector 30 are connected in the space S. In this way, a part of a length required to connect the board-side connector 24, the relay connector 90 and the connector 30 can be arranged in the holding tube portion 16, and a length in a front-rear direction of a part of the case 12 except the holding tube portion 16 can be made shorter. In this way, the device 10 can be reduced in size as a whole.

Note that the inner opening of the outer conductor 40 may be formed to be longer and located at the same position as or inside the bottom portion 15 of the mating connection conductor 50.

The other end of the outer conductor 40 projects outward from the holding/partitioning portion 17. An outer conductor of the cable-side connector is connected to the outer end part of the outer conductor 40, and an outer end part of the inner conductor 34 is inserted and connected to an inner conductor of the cable-side connector.

### Concerning Electrical Connection Structure of Outer Conductor and Mating Connection Conductor

The mating connection conductor 50 includes an opening 54 extending around a center axis of the outer conductor 40. The connector 30 is provided with the plurality of spring connecting portions 62 arranged along a circumferential direction of the outer conductor 40 on an outer peripheral side of the outer conductor 40. Each of the plurality of spring connecting portions 62 extends from the edge of the opening 54 toward the outer conductor 40 and is resiliently pressed against an outer peripheral part of the outer conductor 40 when viewed along the center axis X of the outer conductor 40. That is, the spring connecting portion 62 is located between the outer peripheral part of the outer conductor 40 and the edge of the opening 54 when viewed along the center axis X of the outer conductor 40. A spring fulcrum 62a of the spring connecting portion 62 is located closer to the edge of the opening 54 than to the outer peripheral part of the outer conductor 40. The spring connecting portion 62 can be resiliently deformed with the spring fulcrum 62a as a center and largely displace an end part thereof on the outer peripheral side of the outer conductor 40.

An example in which the spring connecting portion 62 is configured as a part of an intervening member 60 separate from the outer conductor 40 and the mating connection conductor 50 is shown in this embodiment.

More specifically, the opening 54 is formed in the bottom portion 52 of the mating connection conductor 50. The opening 54 is formed at a position facing the inner opening of the outer conductor 40. The size of the opening 54 is the same as or larger than that of the inner opening of the outer conductor 40. A center of the opening 54 is located on the center axis of the outer conductor 40.

In this embodiment, the mating connection conductor 50 includes an extended tube portion 55 extending outward from the edge of the opening 54. A length of the extended tube portion 55 is shorter than an axial length of the cylindrical space S2 on the inner side, out of the holding tube portion 16. The extended tube portion 55 is arranged in the cylindrical space S2. In this arranged state, the tip of the extended tube portion 55 is separated from a back side part of the cylindrical space S2.

The intervening member 60 includes an annular portion 66 and the plurality of spring connecting portions 62. The intervening member 60 may be formed by deep drawing a metal material, may be formed by press-working a metal plate, may be formed by die molding or may be formed by cutting. In any case, the intervening member 60 is separate from the outer conductor 40 and the mating connection conductor 50.

The annular portion 66 is formed into an annular shape along the opening 54. The annular portion 66 is electrically connected to the mating connection conductor 50 on the outer periphery of the opening 54 while being arranged along the opening 54.

Further, the annular portion 66 is located outward away from the outer peripheral part of the outer conductor 40. The annular portion 66 supports the plurality of spring connecting portions 62 at respective positions along the opening 54. In this way, the plurality of spring connecting portions 62 are supported side by side along the circumferential direction of the outer conductor 40 on the outer peripheral side of the outer conductor 40. Further, the annular portion 66 supports the plurality of spring connecting portions 62 cantilevered toward the outer conductor 40. In this way, the spring connecting portion 62 is supported in such a posture as to extend from the spring fulcrum 62a toward the outer conductor 40 with a part connected to the annular portion 66 as the spring fulcrum 62a.

More specifically, the annular portion 66 includes an intervening tube portion 67 and a protruding portion 68.

The intervening tube portion 67 is formed into a tubular shape. An outer diameter of the intervening tube portion 67 is equal to or smaller than that of the opening 54. The outer diameter of the intervening tube portion 67 is preferably nearly equal to the diameter of the opening 54 so that the intervening tube portion 67 is positioned in a direction orthogonal to an axial direction of the intervening tube portion 67 in the opening 54 with the intervening tube portion 67 inserted in the opening 54. An axial length of the intervening tube portion 67 is shorter than that of the cylindrical space S2. In this way, a space, in which the spring connecting portions 62 extend, is provided between the tip of the intervening tube portion 67 and the back part of the cylindrical space S2. The spring connecting portions 62 are arranged into the cylindrical space S1 from the back side of the cylindrical space S2. The axial length of the intervening tube portion 67 is set to be equal to that of the extended tube portion 55. The intervening tube portion 67 is arranged in the extended tube portion 55 with the outer peripheral surface of the intervening tube portion 67 held in contact with the inner peripheral surface of the extended tube portion 55.

An inner opening of the intervening tube portion 67 is a first opening 67a. The first opening 67a is connected to the bottom portion 52 of the mating connection conductor 50 and open toward the inside of the mating connection conductor 50. An outer opening of the intervening tube portion 67 is a second opening 67b. The second opening 67b extends toward the back side of the cylindrical space S2. In this embodiment, the second opening 67b is located inside the outer opening of the extended tube portion 55. In this embodiment, the second opening 67b and the inner opening of the holding tube portion 16 are located at the same position in a direction along the center axis of the outer conductor 40, but this is not essential.

The protruding portion 68 extends outward from the edge of the first opening 67a. In this embodiment, the protruding portion 68 is formed into an annular plate shape. The protruding portion may be formed into a polygonal plate shape. The protruding portion may extend outward from a circumferential part of the circular edge of the first opening. In that case, a plurality of protruding portions may be formed and scattered along the circular edge of the first opening.

The protruding portion 68 is located on an outer peripheral side of the opening 54, out of the inner surface of the bottom portion 52, and electrically connected to the bottom portion 52. For example, the protruding portion 68 is electrically connected and fixed to the bottom portion 52 by being welded to the bottom portion 52. The protruding portion may be soldered to the mating connection conductor. The protruding portion may be crimped and fixed by press-working or the like while being overlapped on the bottom portion of the mating connection conductor. For example, one of the protruding portion and the mating connection conductor may be formed with a recess and the other may be formed with a protrusion, and the protruding portion and the mating connection conductor may be fixed in contact with each other by fitting the protrusion into the recess.

In this case, the intervening tube portion 67 projects toward the other principal surface side of the bottom portion 52 of the mating connection conductor 50 through the opening 54. Since the extended tube portion 55 projects from the opening 54 as described above, the intervening tube portion 67 is passed through the inside of the extended tube portion 55.

The protruding portion 68 is fixed to the inner surface of the bottom portion 52 in the above example, but may be fixed to the outer surface of the bottom portion 52.

Further, in the above example, the protruding portion 68 is electrically connected to the mating connection conductor 50 by being directly fixed to the bottom portion 52. It is not essential that the protruding portion 68 is directly fixed to the bottom portion 52. For example, a state where the protruding portion is in contact with and electrically connected to the mating connection conductor may be maintained by the protruding portion being sandwiched between the bottom portion of the mating connection conductor and the bottom part of the second case.

The plurality of spring connecting portions 62 are supported on the edge of the second opening 67b of the intervening tube portion 67 and extend inwardly of that edge. When viewed along the center axis X of the outer conductor 40, the plurality of spring connecting portions 62 are uniformly scattered along the edge of the opening 54 (second opening 67b). In this embodiment, eight spring connecting portions 62 are uniformly scattered along the edge of the opening 54 (second opening 67b) at intervals of 45° with the center axis X of the outer conductor 40 as a center. Note that equal also means equal within a manufacturing error range (e.g. intervals differ within a range of ±5° about the center axis X of the outer conductor 40). It is not essential that the plurality of spring connecting portions are uniformly scattered along the edge of the opening 54 (second opening 67b).

In this embodiment, the base ends (spring fulcrums 62a) of the adjacent spring connecting portions 62 are separated from each other in the direction along the edge of the second opening 67b. In this way, the mutual interference of the adjacent spring connecting portions 62 is more reliably suppressed. Note that it is not essential that the base ends (spring fulcrums) of the adjacent spring connecting portions are separated from each other.

Each spring connecting portion 62 has an elongated shape as a whole and extends from the second opening 67b toward the outer peripheral part of the outer conductor 40. That is, when viewed along the center axis X of the outer conductor 40, the spring connecting portion 62 extends along a radial direction of a circle centered on the center axis X of the outer conductor 40. An end on the outer peripheral side of the spring connecting portion 62 is the spring fulcrum 62a connected to the second opening 67b of the intervening member 60. An end on the inner peripheral side of the spring connecting portion 62 is pressed against the outer peripheral part of the outer conductor 40.

More specifically, the spring connecting portion 62 is shaped to be narrower on the tip than on the base end. In this embodiment, the spring connecting portion 62 includes a spring body 63 and a contacting tip portion 64. The spring body 63 is shaped to be gradually narrowed toward a tip side, whereby the spring connecting portion 62 is formed to be narrower on the tip than on the base end.

The spring body 63 extends in a direction intersecting the center axis X of the outer conductor 40 from the spring fulcrum 62a connected to the second opening 67b, here in an obliquely intersecting direction. Here, the spring body 63 is a plate-like part inclined outward from the spring fulcrum 62a toward the outer peripheral part of the outer conductor 40. The spring body 63 is resiliently deformed around the spring fulcrum 62a, whereby a force for pressing the tip part of the spring connecting portion 62 against the outer peripheral part of the outer conductor 40 can be generated.

The spring body 63 is shaped to be gradually narrowed toward the tip side. The spring body 63 is an example of a gradually narrowed part gradually narrowed toward the tip side. In this embodiment, the spring body 63 is formed into an isosceles trapezoidal shape having a side on the side of the spring fulcrum 62a as a longer lower base and a side on the tip side as a shorter upper base. A length of the spring body 63 is set to be larger than a length obtained by subtracting a radius of the outer conductor 40 from a radius of the second opening 67b, and the spring body 63 can reach the outer peripheral part of the outer conductor 40 from the second opening 67b in an oblique posture with respect to the center axis X of the outer conductor 40.

Since the spring bodies 63 are shaped to be gradually narrowed toward the tip sides, gaps between the adjacent spring connecting portions 62 can be reduced while the mutual interference of the adjacent spring connecting portions 62 is suppressed. A case where spring bodies are shaped to have a constant width is assumed. In this case, it is thought to thin the entire spring bodies to avoid the mutual interference of the tips of the spring bodies. In this case, intervals between the base ends of the adjacent spring bodies are increased. Conversely, if an attempt is made to reduce the gaps between the adjacent spring bodies, it is thought to make the entire spring bodies thick. In this case, the tips of the adjacent spring bodies interfere with each other. Thus, with the spring bodies having a constant width, it is possibly difficult to combine the avoidance of the mutual interference of the tips and a reduction in the gaps between the spring bodies. In contrast, if the spring bodies 63 are shaped to be gradually narrowed toward the tip sides, the avoidance of the mutual interference of the tips and a reduction in the gaps between the spring bodies are easily combined.

Further, the springiness of the spring body can be adjusted by the width of the spring body. Since the spring body 63 includes the gradually narrowed part gradually narrowed toward the tip side, the springiness of the spring connecting portion 62 can be adjusted.

Note that also when the spring body 63 includes the gradually narrowed part gradually narrowed toward the tip side, the entire spring body may not be the gradually narrowed part. A part of the spring body may be the gradually narrowed part. For example, a part of the spring body on the base end side may have a constant width and a part on the tip side may be the gradually narrowed part.

The contacting tip portion 64 is connected to the tip of the spring body 63. That is, the contacting tip portion 64 is a part formed by bending a part of the spring body 63 extending toward the tip side. The spring body 63 and the contacting tip portion 64 are connected to form a V shape. The spring body 63 and the contacting tip portion 64 are connected in a curved manner, and an outer part of that curved part is pressed against the outer peripheral part of the outer conductor 40.

The contacting tip portion 64 extends from the tip of the spring body 63 in a direction oblique to the center axis X of the outer conductor 40 and away from the center axis X. That is, the contacting tip portion 64 is inclined in a direction away from the center axis X toward an outer side along the center axis X. Thus, if the outer conductor 40 is inserted into a space inside the tips of the plurality of spring connecting portions 62, inward facing surfaces of the contacting tip portions 64 are pressed against the outer peripheral part of the outer conductor 40 and the spring connecting portions 62 are easily pushed and expanded toward the outer peripheral side. In this way, the outer conductor 40 can be easily inserted among the plurality of spring connecting portions 62 arranged to form an annular shape.

In this embodiment, unlike the spring body 63, the contacting tip portion 64 is shaped to have a constant width. Further, corner parts of the tip side of the contacting tip portion 64 are rounded. It is not essential that the contacting tip portion 64 is formed into this shape.

The plurality of spring connecting portions 62 are formed to have the same shape. That is, the plurality of spring bodies 62 are formed to be rotationally symmetrical with the center axis X as an axis of symmetry. Thus, the plurality of spring connecting portions 62 are deformed into the same shape with the outer conductor 40 inserted in a center among the plurality of spring connecting portions 62. In this way, the plurality of spring connecting portions 62 are pressed against the outer peripheral part of the outer conductor 40 at the same position in the direction along the center axis X of the outer conductor 40. The same position here also means the same position within a manufacturing error range (e.g. within 5 mm in the direction along the center axis X). If the plurality of spring connecting portions 62 are pressed against the outer peripheral part of the outer conductor 40 at the same position in the direction along the center axis X, gaps due to different positions along the center axis X among the adjacent spring connecting portions 62 are hardly formed. In this way, the gaps between the adjacent spring connecting portions 62 can be made as small as possible.

### Effects, etc.

According to the connector 30 configured as described above, each of the plurality of spring connecting portions 62 arranged along the circumferential direction of the outer conductor 40 extends from the edge of the opening 54 (second opening 67b) toward the outer conductor 40 and is resiliently pressed against the outer peripheral part of the outer conductor 40 on the outer peripheral side of the outer conductor 40 when viewed along the center axis X of the outer conductor 40. Thus, even if relative positions of the mating connection conductor 50 and the outer conductor 40 vary due to manufacturing errors, the thermal expansion/contraction of the second case 14 or the like, the spring connecting portions 62 are stably pressed against the spring connecting portions 62. In this way, the outer conductor 40 and the mating connection conductor 50 are more reliably electrically connected. Further, since each of the plurality of spring connecting portions 62 extends from the edge of the opening 54 (second opening 67b) toward the outer conductor when viewed along the center axis X of the outer conductor 40, the gaps between the spring connecting portions 62 are easily reduced. It is assumed that the spring connecting portions extend from the outer conductor 40 toward the edge of the opening 54 (second opening 67b) and are pressed against the extended tube portion of the mating connection conductor. In this case, it is assumed to be difficult to make the tip parts of the spring connecting portions thicker than the base end parts thereof. Thus, the gaps between the spring connecting portions increase on a side near the extended tube portion on the outer peripheral side. In this case, the respective spring connecting portions 62 can be formed by dividing a tube part extending from the intervening tube portion 67 along the circumferential direction and bending the respective divided parts inwardly. Thus, the gaps between the adjacent spring connecting portions 62 can be made as small as possible. In this way, the gaps can be made as small as possible in a part where the outer conductor 40 and the mating connection conductor 50 are connected and an electromagnetic shielding effect can be enhanced.

Note that gaps for preventing the mutual interference of the spring connecting portions 62 or gaps due to restrictions on working may be formed between the adjacent spring connecting portions 62. The gaps between the adjacent spring connecting portions 62 are preferably sized to be able to effectively shield in a frequency range mainly for shielding. Further, the adjacent spring connecting portions may partially overlap.

Further, since the spring connecting portions 62 are formed in the intervening member 60 separate from the outer conductor 40 and the mating connection conductor 50, the spring connecting portions 62 having desired springiness can be easily formed without being limited by restrictions on manufacturing of the outer conductor 40 and the mating connection conductor 50 and the like. For example, if the mating connection conductor 50 is manufactured by deep drawing to eliminate the gaps, enhance the electromagnetic shielding property and reduce cost, a thickness control of the mating connection conductor 50 and the like are difficult. Thus, it is thought to be difficult to form the spring connecting portions having desired springiness in the mating connection conductor 50. In the intervening member 60 separate from the mating connection conductor 50, the spring connecting portions 62 having an arbitrary thickness and desired springiness can be easily formed regardless of those restrictions.

Further, the protruding portion 68 extending outward from the edge of the first opening 67a of the intervening tube portion 67 is in contact with any one of the principal surfaces of the mating connection conductor 50 on the outer periphery of the opening 54 and the plurality of spring connecting portions 62 are supported on the edge of the second opening 67b and extend inwardly of that edge. Thus, the plurality of spring connecting portions 62 can be brought into contact with the outer conductor 40 at positions different along the axial direction of the outer conductor 40 with respect to the opening 54 of the mating connection conductor 50. In this way, a degree of freedom in arranging the outer conductor 40 with respect to the opening 54 can be enhanced. For example, the inner opening of the outer conductor 40 can be located in the holding tube portion 16 on the outer side with respect to the inner space of the second case 14. In this way, a length in the front-rear direction of the case 12 can be reduced and the case 12 can be reduced in size as a whole by arranging a connecting part of the outer conductor 40 and the relay connector 90 in the holding tube portion 16.

Further, since the protruding portion 68 is fixed to the inner surface of the mating connection conductor 50 on the outer peripheral side of the opening 54 and the intervening tube portion 67 projects toward the outer surface side of the mating connection conductor 50 through the opening 54, the intervening member 60 can be firmly fixed to the mating connection conductor 50.

Further, since each of the plurality of spring connecting portions 62 is so shaped that the contacting tip portion 64 located on the tip is narrower than the spring fulcrum 62a located on the base end, the contacting tip portion 64 can be more reliably pressed against the outer peripheral part of the outer conductor 40 while the mutual interference of the tips of the plurality of spring connecting portions 62 is suppressed.

Further, since the plurality of spring connecting portions 62 extend along the radial direction of the circle centered on the center axis X when viewed along the center axis X of the outer conductor 40, a force for pressing the spring connecting portions 62 against the outer peripheral part of the outer conductor 40 toward the center axis X is easily applied.

Further, if the plurality of spring connecting portions 62 are uniformly scattered along the edge of the opening 54 (second opening 67b) when viewed along the center axis X of the outer conductor 40, the respective spring connecting portions 62 are pressed against the outer conductor 40 in a well-balanced manner.

Further, the plurality of spring connecting portions 62 are pressed against the outer peripheral part of the outer conductor 40 at the same position in the direction along the center axis X. Thus, gaps between the spring connecting portions 62 due to height differences of the spring connecting portions 62 in the direction along the center axis X are hardly formed and the gaps between the spring connecting portions 62 can be made smaller.

Further, since each of the plurality of spring connecting portions 62 includes the contacting tip portion 64 extending from the tip of the spring body 63 in the direction oblique to the center axis X of the outer conductor 40 and away from the center axis X, the outer conductor 40 is easily inserted into a part surrounded by the plurality of spring connecting portions 62.

### Modifications

In this embodiment, the spring connecting portions 62 have been described to be separate from the mating connection conductor 50. However, the spring connecting portions may be parts integrally formed to the mating connection conductor. In this case, the spring connecting portions may be formed to extend inward from the opening of the mating connection conductor.

In the above embodiment, a connection target of the connector 30 has been assumed as a coaxial cable and the connector has been described to include one inner conductor. For example, such as when a connection mode of the connector is a cable including two core wires, the connector is assumed to also include a plurality of inner conductors.

The connector 30 may be applied for the connection of an electrical component and a cable not based on the device 10.

In the above embodiment, the intervening tube portion 67 of the intervening member 60 may be omitted and the plurality of spring connecting portions 62 may extend toward the outer conductor 40 with the opening edge of the protruding portion 68 as base ends. Further, the outer conductor 40 may extend to the same position as the opening 54 of the mating connection conductor 50 or extend inwardly of the opening 54 along the center axis X.

Further, the number of the spring connecting portions 62 is arbitrary. For example, two, three or more spring connecting portions 62 may be provided around the center axis X. Further, a scattered state of the plurality of spring connecting portions 62 around the center axis X is arbitrary.

Note that the respective configurations described in the above embodiment and the respective modifications can be appropriately combined as long as these do not contradict each other.

### LIST OF REFERENCE NUMERALS

10 device
12 case
13 first case
14 second case
15 bottom portion
15p fixing protrusion
16 holding tube portion
17 holding/partitioning portion
17g annular recess
17h holding hole
18a locking protrusion
20 electrical component
21 circuit board
22 imaging element
24 board-side connector
25 board-side inner conductor
26 board-side insulator
27 board-side outer conductor
30 connector
32 terminal module
34 inner conductor
36 insulator
36h through hole
40 outer conductor
50 mating connection conductor
52 bottom portion
52h hole
54 opening
55 extended tube portion
60 intervening member
62 spring connecting portion
62a spring fulcrum
63 spring body (gradually narrowed part)
64 contacting tip portion
66 annular portion
67 intervening tube portion
67a first opening
67b second opening
68 protruding portion
90 relay connector
91 movable-side inner conductor
92 movable-side insulator
93 movable-side outer conductor
S space
S1, S2 cylindrical space
X center axis

1. A connector, comprising:
a terminal module including an inner conductor, an insulator surrounding the inner conductor and a tubular outer conductor surrounding the insulator;
a mating connection conductor including an opening extending around a center axis of the outer conductor; and
a plurality of spring connecting portions arranged side by side along a circumferential direction of the outer conductor on an outer peripheral side of the outer conductor,
the plurality of spring connecting portions being arranged side by side along the circumferential direction of the outer conductor,
each of the plurality of spring connecting portions extending from an edge of the opening toward the outer conductor and being resiliently pressed against an outer peripheral part of the outer conductor when viewed along the center axis of the outer conductor,
each of the plurality of spring connecting portions including a spring body extending in an oblique direction with respect to the center axis of the outer conductor and a contacting tip portion connected to a tip of the spring body,
the contacting tip portion extending from the tip of the spring body in a direction oblique to the center axis of the outer conductor and away from the center axis,
the connector being provided with an intervening member including an annular portion along the opening and the plurality of spring connecting portions, the intervening member being separate from the outer conductor and the mating connection conductor,
the annular portion being electrically connected to the mating connection conductor on an outer periphery of the opening,
the plurality of spring connecting portions being so supported on the annular portion that parts connected to the annular portion serve as spring fulcrums,
the annular portion including an intervening tube portion having a first opening and a second opening, and a protruding portion extending outward from an edge of the first opening,
the mating connection conductor including an extended tube portion,
the intervening tube portion being arranged in the extended tube portion,
the intervening tube portion being in contact with an inner peripheral surface of the extended tube portion,
the protruding portion being in contact with any one of principal surfaces of the mating connection conductor on the outer periphery of the opening, and
the plurality of spring connecting portions being supported on an edge of the second opening and extending inwardly of the edge of the second opening.

2. (canceled)

3. (canceled)

4. The connector of claim 1, wherein:
the protruding portion is fixed to one principal surface of the mating connection conductor on the outer periphery of the opening, and
the intervening tube portion projects toward the other principal surface of the mating connection conductor through the opening.

5. The connector of claim 1, wherein each of the plurality of spring connecting portions is shaped to be narrower on a tip than on a base end.

6. The connector of claim 1, wherein each of the plurality of spring connecting portions includes a gradually narrowed part gradually narrowed toward a tip side.

7. The connector of claim 1, wherein the plurality of spring connecting portions extend in a radial direction of a circle centered on the center axis of the outer conductor when viewed along the center axis of the outer conductor.

8. The connector of claim 7, wherein the plurality of spring connecting portions are uniformly scattered along the edge of the opening when viewed along the center axis of the outer conductor.

9. The connector of claim 1, wherein the plurality of spring connecting portions are pressed against the outer peripheral part of the outer conductor at the same position in a direction along the center axis of the outer conductor.

10. (canceled)
